(19) United States
(12) Patent Application Publication
(10) Pub. No.: US 2006/0169566 A1
(43) Pub. Date: Aug. 3, 2006

(54) Wet type multi-plate clutch

(76) Inventor: Yoshihisa Egawa, Fukuroi-shi (JP)

Correspondence Address: MILES & STOCKBRIDGE PC, 1751 PINNACLE DRIVE, SUITE 500, MCLEAN, VA, 22102-3833, US

(21) Appl. No.: 11/344,010

(22) Filed: Feb. 1, 2006

(30) Foreign Application Priority Data
Feb. 3, 2005 (JP) 2005-027128

(51) Int. Cl. F16D 25/0638

(52) U.S. Cl. 192/85 AA

(57) ABSTRACT

The present invention provides a wet type multi-plate clutch comprising a first friction engaging element coaxially arranged within a clutch housing, a second friction engaging element alternately disposed with the first friction engaging element, and a piston for applying an axial load to engage the first and second friction engaging elements with each other and wherein a projection is provided on an outer periphery of an inner diameter portion of the clutch housing or on an inner periphery of the piston and a recessed portion is provided in the inner periphery of the piston or in the outer periphery of the inner diameter portion of the clutch housing so that a relative rotation between the clutch housing and the piston is prevented by engaging the projection with the recessed portion.

### BACKGROUND OF THE INVENTION

1. Field of the Invention

The present invention relates to a wet type multi-plate clutch used in an automatic transmission of a vehicle and the like. More particularly, the present invention relates to a wet type multi-plate clutch including means for preventing a relative rotation between a clutch housing and a piston.

2. Related Background Art

In a wet type multi-plate clutch, a power is transmitted by engaging a plurality of friction engaging elements disposed within a clutch housing with each other. In order to apply an axial urging force to the friction engaging elements, a piston shiftable in an axial direction is provided within the clutch housing.

The piston is shifted in the axial direction by supplying oil pressure into an oil pressure chamber defined between the piston and the clutch housing, thereby tightening or engaging the friction engaging elements. In order to maintain the oil pressure chamber in a liquid-tight condition, an O-ring is provided on an outer periphery of the piston.

When the piston of the wet type multi-plate clutch is operated, the piston for tightening the friction engaging elements may be rotated by the rotation of the friction engaging elements. If the piston is rotated upon engaging the friction engaging elements, due to the rotation of the piston, the O-ring arranged around the piston may be damaged. Further, due to the rotation of the piston, a spring connected to the piston may be twisted to damage the spring. As a result, peripheral members may be damaged, thereby causing mal-function of the clutch.

In order to solve such problems, for example, in Japanese Utility Model Application Laid-open No. S50-101747 (1975), a drive plate or friction engaging element adjacent to a piston is provided with a pawl portion extending in an axial direction so that, by engaging the pawl portion with a groove or a hole formed in the piston, a relative rotation between a clutch housing and the piston is prevented.

Further, in Japanese Utility Model Application Laid-open No. S50-94345 (1975), by fitting a stop member attached to an outer periphery of a piston into a spline formed in a clutch housing, a relative rotation between the clutch housing and the piston is prevented.

However, as shown in the above-mentioned Japanese Utility Model Application Laid-open No. S50-101747, if the pawl portion is provided on the drive plate, the pawl portion abuts against the groove of the piston repeatedly for preventing the relative rotation, with the result that the drive plate may be deformed due to impact or shock. If such deformation occurs, a normal or correct function of the friction engaging apparatus will be lost.

On the other hand, the above-mentioned Japanese Utility Model Application Laid-open No. S50-94345 causes a problem that the number of parts is increased because an additional member as the stop member is provided on the piston. Further, since the spline groove is formed in the outer diameter portion of the piston, the outer diameter of the piston is increased more than it needs, thereby increasing the cost.

Further, in the above-mentioned Japanese Utility Model Application Laid-open No. 50-101747 and Japanese Utility Model Application Laid-open No. 50-94345, since the relative rotation is prevented by directly engaging the piston with the clutch housing, the relative rotation may not be prevented satisfactorily.

### SUMMARY OF THE INVENTION

Accordingly, an object of the present invention is to provide a wet type multi-plate clutch which can prevent a relative rotation between a clutch housing and a piston with low cost and with a compact construction and which can prevent damage of an O-ring and members around the piston.

To achieve the above object, the present invention provides a wet type multi-plate clutch comprising a first friction engaging element coaxially arranged within a clutch housing, a second friction engaging element alternately disposed with the first friction engaging element, and a piston for applying an axial load to engage the first and second friction engaging elements with each other and wherein a projection is provided on an outer periphery of an inner diameter portion of the clutch housing or on an inner periphery of the piston and a recessed portion is provided in the inner periphery of the piston or in the outer periphery of the inner diameter portion of the clutch housing so that a relative rotation between the clutch housing and the piston is prevented by engaging the projection with the recessed portion.

The present invention has the following advantages.

By engaging the projection provided on the outer periphery of the inner diameter portion of the clutch housing with the recessed portion of the piston, the relative rotation between the piston and the clutch housing can be prevented. As a result, the rotation of the piston is eliminated, thereby reducing wear of parts around the piston and thus preventing damage of such parts. Further, a poor operation of the clutch can be prevented.

Further, by improving an O-ring portion, a compact and low cost wet type multi-plate clutch can be provided.

### BRIEF DESCRIPTION OF THE DRAWINGS

FIG. 1 is an axial sectional view showing a wet type multi-plate clutch according to an embodiment of the present invention;

FIG. 2 is an enlarged view of a portion shown by a circle A in FIG. 1; and

FIG. 3 is an axial sectional view showing an engaging relationship between a piston and a clutch housing.

### DESCRIPTION OF THE PREFERRED EMBODIMENTS

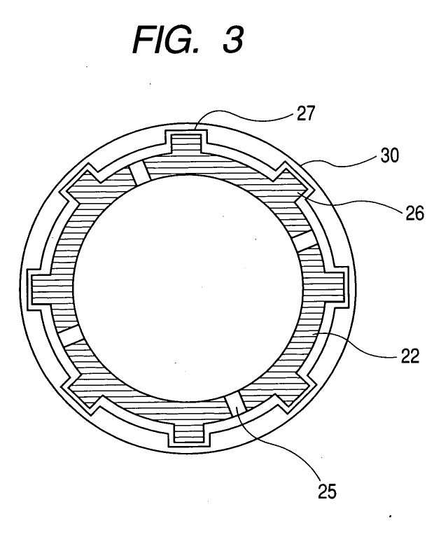

Now, embodiments of the present invention will be fully explained with reference to the accompanying drawings. Incidentally, in the drawings, the same parts or elements are designated by the same reference numerals. Further, the embodiments which will described later are merely examples of the present invention and do not intend to limit the invention. Further, FIG. 3 is an axial sectional view showing an engaging relationship between a piston and a clutch housing.

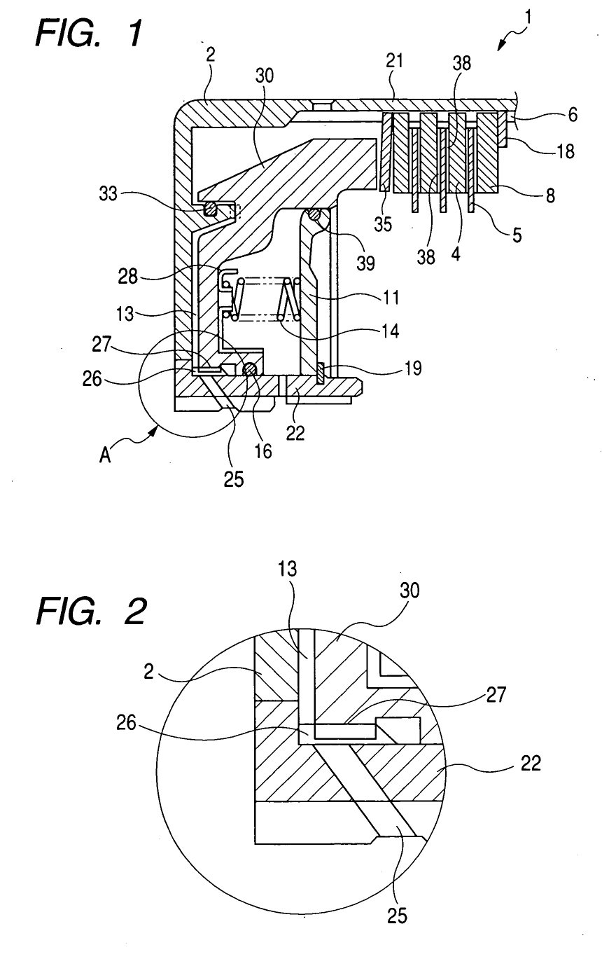

FIG. 1 is an axial sectional view showing a wet type multi-plate clutch 1 according to an embodiment of the present invention, and FIG. 2 is an enlarged view of a portion shown by a circle A in FIG. 1.

In the wet type multi-plate clutch 1, a clutch housing 2 and a hub (not shown) are arranged on a common axis. A spline 6 is formed in an inner peripheral surface of an outer cylindrical portion of the clutch housing 2 and separator plates 4 as first friction engaging elements are received in the spline, and friction plates as second friction engaging elements are received in a spline formed in an outer periphery of the hub (not shown) in such a manner that the separator plates and the friction plates are alternately arranged on a common axis. Friction materials 38 are secured to both surfaces of each friction plate 5.

Within an axial open end portion of the clutch housing 2, there is disposed a backing plate 8 having an axial thickness greater than that of the separator plate 4. By means of a stop ring 18, these friction engaging elements are prevented from dislodging from the clutch housing and axial movements of the friction engaging elements are regulated.

On the other hand, within an axial closed end portion of the clutch housing 2, there is disposed a piston 30. When oil pressure is supplied into an oil chamber 13 defined between the piston and an inner wall of the clutch housing 2, the piston 30 is shifted to the right in FIG. 1 to closely tighten or engage the separator plates 4 and the friction plates 5 with each other through a wave spring 35 provided on a surface of the piston adjacent to the separator plate 4. Oil for the oil pressure is supplied to the oil chamber 13 through an oil port 25 formed in an inner diameter cylindrical portion of the clutch housing 2.

In order to prevent oil leakage, i.e. in order to maintain the oil chamber 13 in an oil-tight condition, a seal ring 33 is provided between the piston 30 and the clutch housing 2 and a seal 16 is provided in the inner cylindrical portion 22 of the clutch housing 2. Further, when the oil pressure is released from the oil chamber 13, the piston 30 is pushed back by a repelling force of a return spring 14, thereby releasing or disengaging the friction engaging elements. The return spring 14 is supported by a snap ring 19 through a canceller 11 fitted in the piston 30 with the interposition of an O-ring 39. The other end of the return spring 14 is held by the piston 30, through a spring holder 28.

Now, an engaging relationship between the piston 30 and the clutch housing 2 will be explained with reference to FIGS. 2 and 3. A plurality of projections 26 extending in radial and axial directions are provided on an outer peripheral surface of the inner diameter cylindrical portion 22 of the clutch housing 2 and are arranged equidistantly along a circumferential direction.

On the other hand, a plurality of recessed portions 27 extending in an axial direction are formed in an inner peripheral surface of the piston 30. As shown in FIG. 3, although the recessed portions 27 of the piston 30 are arranged equidistantly along the circumferential direction, the positions and the number of the recessed portions correspond to those of the projections 26.

With this arrangement, when the projections 26 of the clutch housing 2 are engaged with the recessed portions 27 of the piston 30, a relative rotation between the clutch housing 2 and the piston 30 is prevented. Accordingly, even if the friction engaging elements are rotated, the piston 30 is not rotated by the rotation of the elements, with the result that wear of various parts including the O-rings 33, 16 and 39 can be reduced.

If necessary, at least a part of each projection 26 can be covered by resin material. By doing so, a friction property of the projection can be enhanced, thereby preventing or reducing wear. Further, in place of the fact that the projections 26 are covered by the resin material, an inner surface of each recessed portion 27 of the piston 30 may be covered by resin material. If necessary, both of the projections 26 and the recessed portions 27 may be covered by the resin material.

In the embodiment described above, while an example that the projections 26 are provided on the clutch housing 2 and the recessed portions 27 are provided in the piston 30 was explained, a reverse arrangement can be used. That is to say, the recessed portions may be provided in the clutch housing 2 and the projections to be fitted in the recessed portions may be provided in the piston 30.

This application claims priority from Japanese Patent Application No. 2005-027128 filed on Feb. 3, 2005, which is hereby incorporated by reference herein.

What is claimed is:

1. A wet type multi-plate clutch comprising a first friction engaging element coaxially arranged within a clutch housing, a second friction engaging element alternately disposed with said first friction engaging element, and a piston for applying an axial load to engage said first and second friction engaging elements with each other, wherein:
a projection is provided on an outer periphery of an inner diameter portion of said clutch housing and a recessed portion is provided in an inner periphery of said piston so that a relative rotation between said clutch housing and said piston is prevented by engaging said projection with said recessed portion.

2. A wet type multi-plate clutch according to claim 1, wherein said projection or said recessed portion is covered by resin material.

3. A wet type multi-plate clutch comprising a first friction engaging element coaxially arranged within a clutch housing, a second friction engaging element alternately disposed with said first friction engaging element, and a piston for applying an axial load to engage said first and second friction engaging elements with each other, wherein:
a recessed portion is provided in an outer periphery of an inner diameter portion of said clutch housing and a projection is provided on an inner periphery of said piston so that a relative rotation between said clutch housing and said piston is prevented by engaging said projection with said recessed portion.

4. A wet type multi-plate clutch according to claim 3, wherein said projection or said recessed portion is covered by resin material.
